(19) United States
(12) Patent Application Publication
(10) Pub. No.: US 2011/0045804 A1
(43) Pub. Date: Feb. 24, 2011

(54) System and Method for Providing an Audio Voicemail and its Textual Transcription in a Mobile Device

(76) Inventor: Michael R. Self, Fort Lauderdale, FL (US)

Correspondence Address: ROBERT M. SCHWARTZ, P.A., P.O. BOX 221470, HOLLYWOOD, FL, 33022, US

(21) Appl. No.: 12/858,652

(22) Filed: Aug. 18, 2010

Related U.S. Application Data
(60) Provisional application No. 61/234,712, filed on Aug. 18, 2009.

(51) Int. Cl. H04M 11/10; G10L 15/26

(52) U.S. Cl. 455/413; 704/235; 704/E15.043

(57) ABSTRACT

A system and method are provided for providing, together, an audio voicemail and its transcription in a mobile device, wherein the audio voicemail and its transcription are linked together by a client engine running on the mobile device.

### INDEX TO RELATED APPLICATIONS

This application claims benefit of U.S. Provisional Application No. 61,234,712, filed Aug. 18, 2009, the disclosure of which is incorporated herein by reference in its entirety.

### FIELD OF THE INVENTION

The invention relates to a system and method for providing, together, an audio voicemail and its transcription in a mobile device.

### DESCRIPTION OF THE RELATED ART

Traditionally, voicemails are received and stored as audio files for recall by a mobile device.

U.S. Pat. No. 7,373,141 to Kwon (“the '141 patent”), issued on May 13, 2008, discloses a communication terminal and method for performing a voice-text message conversion process wherein a controlling unit of the device determines whether the voice-text message conversion is required for a specific message based on condition information.

What is needed is a voicemail system for a mobile device that provides together a voicemail and its textual transcription in a mobile device.

### SUMMARY OF THE INVENTION

It is accordingly an object of the invention to provide a mobile device including a client running thereon that receives an audio voicemail and its textual transcription and joins the two together so that they are provided to a user, simultaneously, upon retrieval of the voicemail.

Other features which are considered as characteristic for the invention are set forth in the appended claims.

Although the invention is illustrated and described herein as embodied in a System And Method For Providing An Audio Voicemail And Its Textual Transcription In A Mobile Device, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiment when read in connection with the accompanying drawings.

### BRIEF DESCRIPTION OF THE DRAWING

The present invention is illustrated by way of example, and not by way of limitation, in the figures of the accompanying drawings, in which like reference numerals refer to similar elements and in which:

FIG. 1 is a simplified diagram of a system in accordance with one particular embodiment of the instant invention;

### DESCRIPTION OF THE PREFERRED EMBODIMENTS

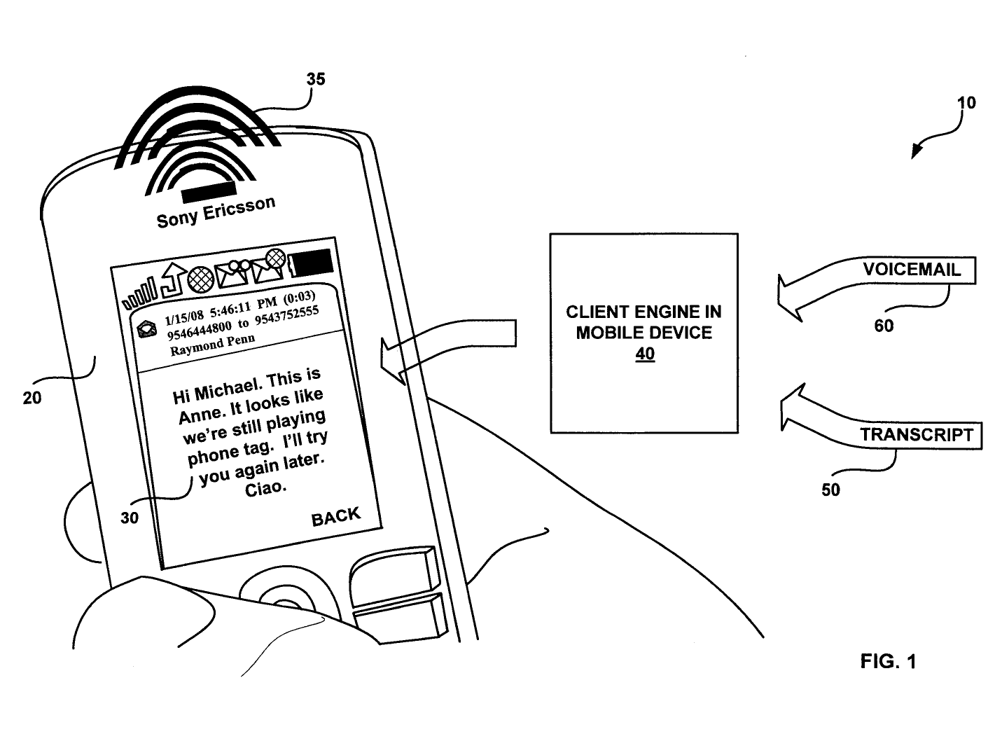

Referring now to FIG. 1, there is shown a simplified diagram of a system 10 for providing a voicemail 60 and its textual transcription 50, together, to a user of a mobile device 20. The mobile device 20 can be a cellular telephone, PDA or other known type of mobile device that traditionally receives voicemail. In accordance with the present embodiment of the invention a voicemail 60 intended for the user of the device 20 has been left with the system. The voicemail 60 and/or information about the storage of a voicemail on a remote server is provided to the mobile device 20. As with traditional voicemail systems, the mobile device 20 can provide the user with an indication that a voicemail has been received, permitting the selection and retrieval of the audio voicemail message from the device memory and/or the server, depending on whether the voicemail or information of the voicemail is transferred to the mobile device 20.

Further, in the instant invention, upon receipt of the voicemail at a remote server (not shown) a transcription of the voicemail 60 is generated and stored by the server. In particular the transcription can be generated by voice-to-text software, speech recognition software, a human operator, or another known method. Upon generation of the voicemail transcript by the server, the transcript of the voicemail 50 and/or an indication of its location on the remote server is additionally provided to the mobile device 20.

The mobile device 20 of the instant application includes a client engine 40 implemented in software or firmware executed by a processor. For example, the client engine can be program instructions running in an application layer of the mobile device 10. The client engine 40 is programmed to join together the voicemail 60 and the transcript 50, for retrieval by the user. In particular, if the voicemail and transcript are actually provided to the mobile device 20, the client engine 40 is programmed to join them contextually (i.e., through pointers or other indicators) so that retrieval of the audio voicemail simultaneously produces both the audio message 35 and the transcript shown on the display 30 of the mobile device 20.

If the server only provides addresses on the server for the voicemail 60 and transcript 50, the client engine 40 is programmed to link the addresses contained in these indicators such that when the audio voicemail message 60 is selected by the user and retrieved from the server, the transcript 50 is simultaneously received, and the transcript displayed on the display 30 while the audio message 35 is played from the speaker of the mobile device.

As such, the instant invention provides a device based client engine that joins the audio message of a voicemail with its textual transcript such that selection of the voicemail from a list of voicemail messages will bring together both the audio message 35 and the textual transcript of the voicemail for simultaneous provision to the user.

It is important to note that the audio message 35 and the transcript 50 may occur synchronously or asynchronously. In the latter case, the audio message 35 may be accessed via the client engine 40 even before the transcript 30 has been completed. Further, once the transcript 30, has been completed, a notification may be sent to the mobile device 20 which may then invoke client engine 40 that an event has occurred. Either device 20 and/or client engine 40 may then access the transcript 30 and store a copy of it locally on device 20. Alternatively, after such notification event client engine 40 may be configured (via user accessible parameters) to not store a copy of the transcript 30 on the device 20 and, instead, may simply indicate through the use of icons or text notifications that such transcript 30 now exists.

Device 20 which may invoke client engine 40 that a voice message 35 exists AND a transcript 30 exists. The client engine 40 may then take action based on configurable parameters to access and/or store audio message 35 and transcript In the former, synchronous mode, a notification is sent to 30 on the device 20.

Note that in both the synchronous and asynchronous examples, the storage of the audio message 35 and the transcript 30, if present on device 20, may be temporary (for example, stored in volatile RAM and not preserved if the device 20 is turned off) or permanent (for example, stored in NONvolatile storage and preserved if the device 20 is turned off).

Note that the above-described embodiments are exemplary and that the above invention is not meant to be limited only to its preferred embodiments. It can be seen that other modifications can be made to the preferred embodiments and still be within the spirit of the present invention.

I claim:

1. A mobile communication device, comprising:
a client engine implemented by data structures stored in memory and executable by a microprocessor to provide a link between an audio voicemail and a transcription of the audio voicemail; and
said client engine additionally configured to provide the textual transcript to a display of the mobile device when the audio message is selected for replay.
